(19) United States
(12) Patent Application Publication
(10) Pub. No.: US 2022/0171899 A1
(43) Pub. Date: Jun. 2, 2022

(54) PROBLEM SOLVING DEVICE, METHOD, AND PROGRAM

(71) Applicant: NIPPON TELEGRAPH AND TELEPHONE CORPORATION, Tokyo (JP)

(72) Inventors: Yuya HIKIMA, Tokyo (JP); Hiroyuki TODA, Tokyo (JP); Takeshi KURASHIMA, Tokyo (JP); Yasunori AKAGI, Tokyo (JP)

(73) Assignee: NIPPON TELEGRAPH AND TELEPHONE CORPORATION, Tokyo (JP)

(21) Appl. No.: 17/436,589

(22) PCT Filed: Feb. 27, 2020
(86) PCT No.: PCT/JP2020/008065

§ 371 Date: Sep. 3, 2021

(30) Foreign Application Priority Data
Mar. 5, 2019 (JP) 2019-039692

(51) Int. Cl. G06F 30/20

(52) U.S. Cl. CPC G06F 30/20; G06F 2111/04

(57) ABSTRACT

A solution to an optimization problem can be obtained while reducing the amount of computation.

An optimization problem reformulating unit 130 reformulates an optimization problem as a processing target into an optimization problem in which a constraint on a discrete variable and a constraint on a continuous variable are separated. A discrete variable optimizing unit 160 optimizes the discrete variable in the reformulated optimization problem while fixing the continuous variable at a certain point. A continuous variable optimizing unit 180 optimizes the continuous variable in the reformulated optimization problem while fixing the discrete variable to a certain point. A link changing unit 200 changes a link coefficient representing the influence of a term in which the discrete variable and the continuous variable are multiplied by each other in the reformulated optimization problem. A management unit 150 causes the processing by the discrete variable optimizing unit 160, the processing by the continuous variable optimizing unit 180, and the processing by the link changing unit 200 to be repeated until a predetermined condition is satisfied.

### TECHNICAL FIELD

The present invention relates to a problem solving device, method, and program, and particularly to a problem solving device, method, and program for obtaining a solution to an optimization problem.

### BACKGROUND ART

Existing solutions to 0-1 mixed-integer quadratic programming problems with applications such as control optimization and scheduling optimization include branch and bound methods as an exact solution (NPL 1) and Alternating Direction Method of Multipliers (ADMM) as a heuristic solution (NPL 2). According to the branch and bound method, a global optimal solution is obtained for each discrete variable while performing division into cases. According to ADMM, a problem is deformed, and each variable is alternately optimized for an augmented Lagrange function thereof.

### CITATION LIST

### Non Patent Literature

[NPL 1] Lawler, E. L., Wood, D. E. (1966). Branch-and-bound methods: A survey. Operations research, 14(4), 699-719.
[NPL 2] Takapoui, R., Moehle, N., Boyd, S., Bemporad, A. (2017). A simple effective heuristic for embedded mixed-integer quadratic programming. International Journal of Control, 1-11.

### SUMMARY OF THE INVENTION

### Technical Problem

However, the conventional methods described above are encountered with the following unsolved problems.

According to the branch and bound method as an exact solution, case dividing is performed for every single discrete variable, and therefore there may be an exponential increase in the amount of computation. According to ADMM as a heuristic solution, the final solution may not satisfy the constraints or a solution with a bad objective function value may result.

With the foregoing in view, it is an object of the present invention to provide a device, method, and program for solving a problem which allow a solution to an optimization problem to be obtained while reducing the amount of computation.

### Means for Solving the Problem

In order to achieve the object, a problem solving device according to a first aspect outputs a solution to an optimization problem which is a quadratic programming problem including a discrete variable and a continuous variable and which can be formulated into a quadratic programming problem having a constraint on the discrete variable and a constraint on the continuous variable in a separated state, and the device includes an optimization problem reformulating unit which reformulates an optimization problem as a processing target into an optimization problem in which the constraint on the discrete variable and the constraint on the continuous variable are separated, a discrete variable optimizing unit which optimizes the discrete variable in the reformulated optimization problem while fixing the continuous variable at a certain point, a continuous variable optimizing unit which optimizes the continuous variable in the reformulated optimization problem while fixing the discrete variable at a certain point, a link changing unit which changes a link coefficient representing the influence of a term in which the discrete variable and the continuous variable are multiplied by each other in the reformulated optimization problem, and a management unit which causes the optimization by the discrete variable optimizing unit, the optimization by the continuous variable optimizing unit, and the changing by the link changing unit to be repeated until a predetermined stop condition is satisfied.

A problem solving method according to a second aspect is a method in a problem solving device for outputting a solution to an optimization problem which is a quadratic programming problem including a discrete variable and a continuous variable and which can be formulated into a quadratic programming problem having a constraint on the discrete variable and a constraint on the continuous variable in a separated state, and the method includes reformulating an optimization problem as a processing target into an optimization problem in which the constraint on the discrete variable and the constraint on the continuous variable are separated using an optimization problem reformulating unit, optimizing the discrete variable in the reformulated optimization problem while fixing the continuous variable at a certain point using a discrete variable optimizing unit, optimizing the continuous variable in the reformulated optimization problem while fixing the discrete variable at a certain point using a continuous variable optimizing unit, changing a link coefficient representing the influence of a term in which the discrete variable and the continuous variable are multiplied by each other in the reformulated optimization problem using a link changing unit, and repeating the optimization by the discrete variable optimizing unit, the optimization by the continuous variable optimizing unit, and the changing by the link changing unit until a predetermined stop condition is satisfied using a management unit.

A program according to a third aspect of the invention is a program for performing problem solving processing for outputting a solution to an optimization problem which is a quadratic programming problem including a discrete variable and a continuous variable and which can be formulated into a quadratic programming problem having a constraint on the discrete variable and a constraint on the continuous variable in a separated state, and the program causes a computer to execute the steps of reformulating an optimization problem as a processing target into an optimization problem in which the constraint on the discrete variable and the constraint on the continuous variable are separated, optimizing the discrete variable in the reformulated optimization problem while fixing the continuous variable at a certain point, optimizing the continuous variable in the reformulated optimization problem while fixing the discrete variable at a certain point, changing a link coefficient representing the influence of a term in which the discrete variable and the continuous variable are multiplied by each other in the reformulated optimization problem, and repeating the optimization for the discrete variable, the optimization for the continuous variable, and the changing for the link coefficient until a predetermined stop condition is satisfied.

### Effects of the Invention

The device, method, and program for solving a problem according to an embodiment of the present invention allow a solution to an optimization problem to be obtained while reducing the amount of computation.

### BRIEF DESCRIPTION OF DRAWINGS

FIG. 1 is a block diagram of a configuration of a problem solving device according to a first embodiment of the present invention.

FIG. 2 illustrates an example of a problem parameter storage unit.

FIG. 3 illustrates an example of an optimization problem parameter storage unit.

FIG. 4 illustrates an example of a discrete variable value storage unit.

FIG. 5 illustrates an example of a continuous variable value storage unit.

FIG. 6 illustrates an example of a parameter storage unit.

FIG. 7 illustrates an example of a decision variable value storage unit.

FIG. 8 is a schematic block diagram of an exemplary computer which functions as a problem solving device.

FIG. 9 is a flowchart for illustrating a problem solving processing routine in a problem solving device according to a first embodiment of the present invention.

FIG. 10 illustrates an example of a problem parameter storage unit.

FIG. 11 illustrates an example of an optimization problem parameter storage unit.

FIG. 12 illustrates an example of a discrete variable value storage unit.

FIG. 13 illustrates an example of a continuous variable value storage unit.

FIG. 14 illustrates an example of a parameter storage unit.

FIG. 15 illustrates an example of a decision variable value storage unit.

### DESCRIPTION OF EMBODIMENTS

Embodiments of the present invention will be described in detail in conjunction with the drawings.

### Summary of Invention in Relation to Embodiment

A summary of the invention in relation to the embodiments will be described.

According to the embodiments of the present invention, an optimization problem is divided into a part for continuous variables and a part for discrete variables, and a final solution is obtained by solving the parts iteratively. An optimization problem for the discrete variable part is transformed appropriately by estimating an effective constraint. This results in a problem format which allows an Ising machine to be used therefor, so that the problem can be solved at high speed. Also, when a barrier function is set appropriately for an objective function, it becomes possible to work on the solution to satisfy a constraint. Furthermore, when a coefficient parameter is introduced in the part of the objective function where continuous and discrete variables are multiplied by each other, the influence of the part is changed for each iteration. As a result, a final solution with a relatively good objective function value can be obtained.

Here, the Ising machine is a generic term for machines which express a combinatorial optimization problem as an Ising model (Reference 1) and solve the combinatorial optimization problem. Specific examples of the Ising machines include D-wave (Reference 2), Fujitsu Digital Annealer (Reference 2), CMOS Annealing Machine (Reference 4), and LASOLV (Reference 5).
[Reference 1] AIST: Waseda Selected to Engage in Research and Development of Common Software Platform for Using Quantum Annealing Machines (last visited Jan. 25, 2018) URL: https://www.aist.go.jp/aist j/press release/pr2018/pr20181009/pr20181009.html#b
[Reference 2] D-wave The quantum computing company (last visited Jan. 25, 2018) URL: https://www.dwavesys.com/home
[Reference 3] Digital Annealer: Fujitsu's New Architecture Computer: Fujitsu Japan (last visited Jan. 25, 2018), URL: http://www.fujitsu.com/jp/digitalannealer/
[Reference 4] News Release: Sep. 19, 2018: Hitachi-Hitachi, Ltd. (last visited Jan. 25, 2018), URL: http://www.hitachi.co.jp/New/cnews/month/2018/09/0919.html [Reference 5] Hikari wo tukatta atarashii konpyuta LASOLV (LASOLV, a new light-based computer) (last visited Jan. 25, 2018), URL: http://www.ntt.co.jp/event/2018/pdf/ceatec18/10 future-tech ntt.pdf

The problem which can be solved by the Ising machine is for example an unconstrained 0-1 integer quadratic programming problem as follows.

$$\begin{matrix}[ Math . 1 ] & \\ {min}_{z} {z}^{T} Pz + {q}^{T} z \\ s . t . z ∈ {\{ 0 , 1 \}}^{n} & \end{matrix}$$

Here,

### P

represents an n×n constant matrix,
q
is an n-dimensional constant vector.

### First Embodiment

### <Configuration of the Problem Solving Device According to the First Embodiment of the Invention>

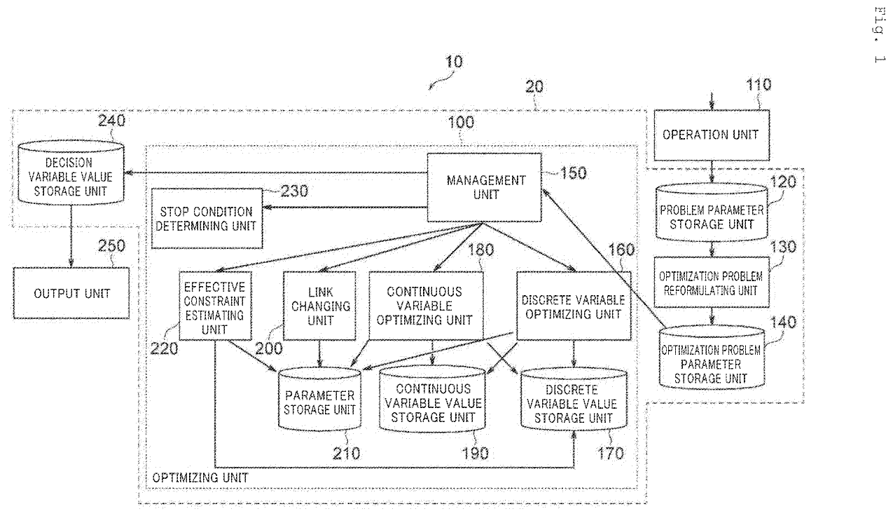

Now, the configuration of the problem solving device according to the embodiment of the present invention will be described. As shown in FIG. 1, the problem solving device 10 according to the embodiment of the invention includes a CPU, a RAM, and a ROM which stores a program and various kinds of data for executing a problem solving processing routine which will be described. As shown in FIG. 1, the problem solving device 10 comprises, as functions, an operation unit 110, an arithmetic unit 20, and an output unit 250.

The operation unit 110 accepts, as a processing target, an optimization problem which can be formulated into a 0-1 mixed-integer quadratic programming problem in which constraints on discrete and continuous variables are separated. Here, the 0-1 mixed-integer quadratic programming problem is a quadratic programming problem which has both discrete and continuous variables as variables among which the discrete variable is 0 or 1.

Specifically, a problem as follows is accepted.

$$\begin{matrix}[ Math . 2 ] & \\ {min}_{z , x} {x}^{T} {P}_{1} x + {q}_{1}^{T} x + {z}^{T} {P}_{2} z + {q}_{2}^{T} z + {x}^{T} {P}_{3} z + r \\ s . t . {\sum }_{j ∈ {J}^{i}} {α}_{ij} {z}_{j} = {v}_{i} , i = 1 , 2 , … , {m}_{1} \\ {\sum }_{j ∈ {K}^{i}} {β}_{ij} {z}_{j} \leq {w}_{i} , i = 1 , 2 , … , {m}_{2} \\ Ax = b , Cx \leq d \\ {e}_{i}^{T} x + {f}_{i} \leq {h}_{i} {z}_{g ( i )} , i = 1 , 2 , … , {m}_{3} \\ z ∈ {\{ 0 , 1 \}}^{{n}_{1}} , x ∈ {ℝ}^{{n}_{2}} & ( 1 )\end{matrix}$$

Note that decision variables are

z,x
and the constants are

$${P}_{1} , {P}_{2} , {P}_{3} , {q}_{1} , {q}_{2} , r , v , {α}_{i} ( i = 1 , 2 , … , {m}_{1} ) , w , \\ {β}_{i} ( i = 1 , 2 , … , {m}_{2} ) , A , B , C , d , {e}_{i} ( i = 1 , 2 , … , {m}_{3} ) , f , h .$$

In addition, the following holds,

$$g \text{:} \{ 1 , 2 , … , {m}_{3} \} \to \{ 1 , 2 , … , {n}_{2} \}$$

and the following holds for all i and j.

$${α}_{ij} ∈ \{ 1 , - 1 \} , {β}_{ij} ∈ \{ 1 , - 1 \}$$

Here, introduction of a new discrete variable

$${z}^{′} ∈ \{ 0 , 1 \}$$

and an equality constraint

$${z}^{′} = 1 - {z}_{g ( i )}$$

allows the following expression

$${e}_{i}^{T} x + {f}_{i} \leq {h}_{i} {z}_{g ( i )}$$

to be transformed into the following expression

$${e}_{i}^{T} x + {f}_{i} - {h}_{i} \leq - {h}_{i} {z}^{′}$$

and therefore, if

$$h \geq 0$$

holds in the problem, generality is not lost.

Problems can be changed into the above problem form in many applications, and examples of the problems include a power distribution determination problem among vehicles with different kinds of power (Reference 8), an optimization problem for economic dispatch (Reference 9), a scheduling problem for a power plant (Reference 10), and an optimal vehicle routing problem (Reference 11).
[Reference 8] Boyd, S., Vandenberghe, L. (2004). Convex optimization. Cambridge university press.
[Reference 9] Papageorgiou, L. G., Fraga, E. S. (2007). A mixed integer quadratic programming formulation for the economic dispatch of generators with prohibited operating zones. Electric power systems research, 77(10), 1292-1296.
[Reference 10] Catalao, J. P. D. S., Pousinho, H. M. I., Mendes, V. M. F. (2010). Scheduling of head-dependent cascaded hydro systems: Mixed-integer quadratic programming approach. Energy Conversion and Management, 51(3), 524-530.
[Reference 11] Schouwenaars, T., De Moor, B., Feron, E., How, J. (2001). Mixed integer programming for multi-vehicle path planning. In Control Conference (ECC), 2001 European (pp. 2603-2608) IEEE.

The arithmetic unit 20 includes a problem parameter storage unit 120, an optimization problem reformulating unit 130, an optimization problem parameter storage unit 140, an optimizing unit 100, and a decision variable value storage unit 240.

The optimizing unit 100 includes a management unit 150, a discrete variable optimizing unit 160, a discrete variable value storage unit 170, a continuous variable optimizing unit 180, a continuous variable value storage unit 190, a link changing unit 200, a parameter storage unit 210, an effective constraint estimating unit 220, and a stop condition determining unit 230.

The optimization problem reformulating unit 130 reformulates an accepted optimization problem into a different problem format. The discrete variable optimizing unit 160 transforms a problem obtained by extracting only the discrete variable part from the reformulated problem and solves the problem by using an Ising machine. The continuous variable optimizing unit 180 solves a problem obtained by extracting only the continuous variable part from the reformulated problem by using a classical computer. The link changing unit 200 prevents the final solution from becoming an extremely bad solution by changing the influence of the term in which the discrete and continuous variables are multiplied by each other. The effective constraint estimating unit 220 estimates an inequality for a discrete variable which allows an equality to be established in a solution. Therefore, the discrete variable optimizing unit 160 can transform the original problem into a problem which can be solved by the Ising machine. The stop condition determining unit 230 determines whether a stop condition is satisfied and ends the iteration when the stop condition is satisfied. The management unit 150 repeatedly calls the discrete variable optimizing unit 160, the continuous variable optimizing unit 180, the link changing unit 200, the effective constraint estimating unit 220, and the stop condition determining unit 230 and perform execution.

Next, various parts of the problem solving device 10 will be described in detail.

The problem parameter storage unit 120 stores constant parameters in the optimization problem, reads a constant parameter in response to a request from the problem solving device 10, and transmits the parameter to the optimization problem reformulating unit 130. Specifically, the information to be transmitted is information on constant parameters in the optimization problem (1) as follows.

$${P}_{1} , \\ {P}_{2} , \\ {P}_{3} , \\ {q}_{1} , \\ {q}_{2} , \\ r , \\ {v}_{,}$$

$${α}_{i} ( i = 1 , 2 , … , {m}_{1} ) , \\ ω , \\ {β}_{i} ( i = 1 , 2 , … , {m}_{2} ) , \\ A , \\ b , \\ C , \\ d , \\ {e}_{i} ( i = 1 , 2 , … , {m}_{3} ) , \\ f , \\ h$$

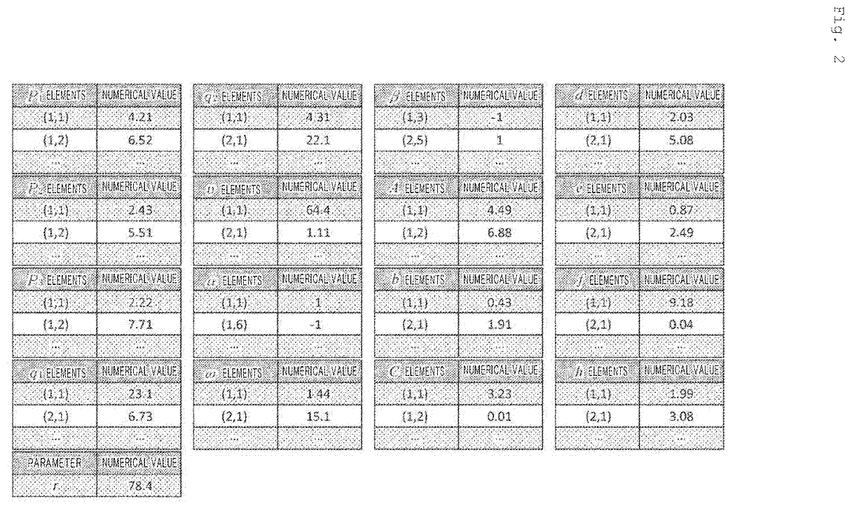

Examples of the parameters stored in the problem parameter storage unit 120 are shown in FIG. 2.

The optimization problem reformulating unit 130 uses the problem parameter transmitted from the problem parameter storage unit 120 to formulate an optimization problem into a 0-1 mixed-integer quadratic programming problem in which the constraint on the discrete variable and the constraint on the continuous variable are separated. Hereinafter, an example of the formulation method will be described.

First, as a sufficiently large constant M and a slack variable represented by the following expression

$$s ∈ {ℝ}^{{m}_{3}}$$

are introduced. In this way, the optimization problem (1) can be formulated as follows so that the constraints on the discrete variable and the continuous variable can be separated.

$$\begin{matrix} [ Math . 3 ] & \\ {min}_{z , x , s} {x}^{T} {P}_{1} x + {q}_{1}^{T} x + {z}^{T} {P}_{2} z + {q}_{2}^{T} z + {x}^{T} {P}_{3} z + r + M {\sum }_{i = 1}^{{m}_{3}} ( 1 - {z}_{g ( i )} ) {s}_{i} \\ s . t . {\sum }_{j ∈ {J}^{i}} {α}_{ij} {z}_{j} = {v}_{i} , i = 1 , 2 , … , {m}_{1} \\ {\sum }_{j ∈ {K}^{i}} {β}_{ij} {z}_{j} \leq {w}_{i} , i = 1 , 2 , … , {m}_{2} \\ Ax = b , Cx \leq d \\ {e}_{i}^{T} x + {f}_{i} \leq {s}_{i} , i = 1 , 2 , … , {m}_{3} \\ 0 \leq {s}_{i} \leq {h}_{i} , i = 1 , 2 , … , {m}_{3} \\ z ∈ {\{ 0 , 1 \}}^{{n}_{1}} , x ∈ {ℝ}^{{n}_{2}} , s ∈ {ℝ}^{{m}_{3}} & ( 2 )\end{matrix}$$

This problem is a 0-1 mixed-integer quadratic programming problem in which the constraints on discrete and continuous variables are separated, the problem can be transformed into the following form by redefining the decision variables x and s as the decision variable x and changing the constants.

$$\begin{matrix}[ Math . 4 ] & \\ {min}_{z , x} {x}^{T} {P}_{1} x + {q}_{1}^{T} x + {z}^{T} {P}_{2} z + {q}_{2}^{T} z + {x}^{T} {P}_{3} z + r \\ s . t . {\sum }_{j ∈ {J}^{i}} {α}_{ij} {z}_{j} = {v}_{i} , i = 1 , 2 , … , {m}_{1} \\ {\sum }_{j ∈ {K}^{i}} {β}_{ij} {z}_{j} \leq {w}_{i} , i = 1 , 2 , … , {m}_{2} \\ Ax = b , Cx \leq d \\ z ∈ {\{ 0 , 1 ]}^{{n}_{1}} , x ∈ {ℝ}^{{n}_{2}} & \end{matrix}$$

Here, the decision variables are

z, x while the constants are as follows.

$${P}_{1} , \\ {P}_{2} , \\ {P}_{3} , \\ {q}_{1} , \\ {q}_{2} , \\ r , \\ {v}_{,}$$

$${α}_{i} ( i = 1 , 2 , … , {m}_{1} ) , \\ ω , \\ {β}_{i} ( i = 1 , 2 , … , {m}_{2} ) , \\ A , \\ b , \\ C , \\ d$$

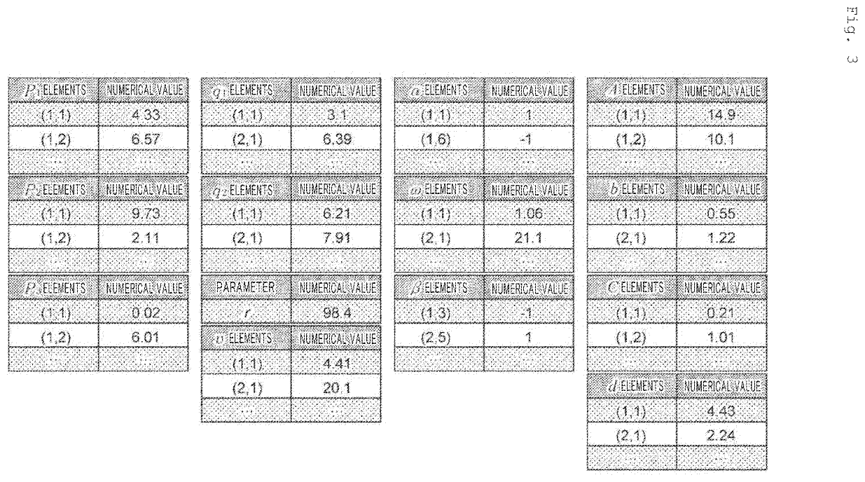

In this way, the optimization problem (2) reformulated by the optimization problem reformulating unit 130 is stored in the optimization problem parameter storage unit 140. Examples stored in the optimization problem parameter storage unit 140 are shown in FIG. 3. The optimization problem parameter storage unit 140 reads out an optimization problem parameter in response to a request from the problem solving device 10 and transmits the parameter to the management unit 150.

The management unit 150 calls the discrete variable optimizing unit 160, the continuous variable optimizing unit 180, the link changing unit 200, the effective constraint estimating unit 220, and the stop condition determining unit 230 according to the procedure of an algorithm which alternately optimizes discrete variables and continuous variables (which will be described). When it is determined that the stop condition is satisfied by the stop condition determining unit 230, the management unit 150 stores the obtained solution in the decision variable value storage unit 240. The specific algorithm is as follows.

The discrete variable optimizing unit 160 optimizes a discrete variable in the optimization problem (2) when a continuous variable is fixed in a certain point. When the continuous variable in the optimization problem (2) is fixed as

x̅
the constant term is removed, and when a coefficient η is introduced in the following,

$${\overline{x}}^{T} {P}_{3} z$$

the optimization problem (2) is obtained as the following optimization problem.

$$\begin{matrix}[ Math . 5 ] \\ min {z}^{T} {P}_{2} z + {q}_{2}^{T} z + η {\overline{x}}^{T} {P}_{3} z \\ s . t . {\sum }_{j ∈ {J}^{i}} {α}_{ij} {z}_{j} = {v}_{i} , i = 1 , 2 , … , {m}_{1} \\ {\sum }_{j ∈ {K}^{i}} {β}_{ij} {z}_{j} \leq {w}_{i} , i = 1 , 2 , … , {m}_{2} \\ z ∈ {\{ 0 , 1 ]}^{{n}_{1}}\end{matrix}$$

Here, a changes the degree of influence of the term in which the continuous and discrete variables are multiplied by each other, and as n increases, the problem takes more into account the following continuous variable:

x̅.
The coefficient η is obtained by referring to a value stored in the parameter storage unit 210 by the link changing unit 200.

The discrete variable optimizing unit 160 changes the above optimization problem (2) as follows in order to solve the problem by an Ising machine in each iteration.

$$\begin{matrix} [ Math . 6 ] & \\ {\begin{matrix}min {z}^{T} {P}_{z} z + {q}_{2}^{T} z + η {x}^{T} {P}_{3} z + & [ Math . 6 ]\end{matrix}}_{1} {\sum }_{i = 1}^{{m}_{1}} {( {\sum }_{j ∈ {J}^{i}} {α}_{ij} {z}_{j} - {v}_{i} )}^{2} + {μ}_{2} {\sum }_{i ∈ S} {( {\sum }_{j ∈ {K}^{i}} {β}_{ij} {z}_{j} - {w}_{i} + 0.5 )}^{2} & \end{matrix}$$

Here, the following term is a barrier function for the equality constraint, and the solution satisfies the equality constraint when the penalty parameter pi is sufficiently large.

$${μ}_{1} {\sum }_{i = 1}^{{m}_{1}} {( {\sum }_{j ∈ {J}^{i}} {α}_{ij} {z}_{j} - {v}_{i} )}^{2}$$

The following term is a barrier function for the inequality constraint,

$${μ}_{2} {\sum }_{i ∈ S} {( {\sum }_{j ∈ K} , {β}_{ij} {z}_{j} - {ω}_{i} + 0.5 )}^{2}$$

and when the penalty parameter μ₂ is sufficiently large, the solution is determined to satisfy as much as possible,
for

$$i ∈ S , \\ {\sum }_{j ∈ {K}^{i}} {β}_{ij} {z}_{j} = {ω}_{i}$$

$$or$$

$${\sum }_{j ∈ {K}^{i}} {β}_{ij} {z}_{j} = {ω}_{i} - 1$$

where

### S

is an index set of constraints estimated to be effective among inequality constraints and obtained by referring to those stored in the parameter storage unit 210 using the effective constraint estimating unit 220. Since the problem is an unconstrained quadratic programming problem with only 0-1 variables, the problem can be solved using each Ising machine.

There has been a proposed approach for transforming an inequality constraint on a discrete variable into an equality constraint by introducing a new variable (Reference 12), but the above-described approach for estimating an effective constraint does not need to introduce a new variable and is easy to implement on the Ising machine which is limited in the number of variables.

Next, the continuous variable optimizing unit 180 optimizes the continuous variable in the optimization problem when the discrete variable is fixed. The discrete variable in the original optimization problem (2) is fixed as

[symbol]

the constant term is removed, and as n is introduced in the following,

$${x}^{⊤} {P}_{3} \overline{z}$$

the optimization problem (2) is obtained as the following optimization problem.

$$min {x}^{⊤} {P}_{1} x + {q}_{1}^{⊤} x + {η x}^{⊤} {P}_{3} \overline{z} \\ s . t . \\ Ax = b , \\ Cx \leq d \\ x \leq {ℝ}^{{n}_{2}} \qquad [ Math . 7 ]$$

Here, as η increases, the problem takes more into account the discrete variable:

[symbol]

.
The coefficient η is obtained by referring to those stored in the parameter storage unit 210 by the link changing unit 200.

The above optimization problem is a convex quadratic programming problem when

### P₁

is a positive-semidefinite symmetry matrix and can be solved using various interior-point methods such as a primal-dual interior point method.

In addition to the above optimization of the discrete variable part and optimization of the continuous variable part, the link changing unit 200 updates the link coefficient n sequentially in the part of the algorithm for updating the parameters which will be described.

$${η}^{k + 1} := min \{ 1 , {η}^{k} + γ \}$$

In this way, the influence of the term in which the discrete and continuous variables are multiplied by each other is gradually increased to prevent convergence to an extremely bad solution.

The effective constraint estimating unit 220 estimates, as effective constraints, constraints which are not satisfied in a solution at present and constraints satisfied by an equality among constraints on discrete variables and including inequalities. Specifically, the effective constraint estimating unit 220 estimates a set of constraints

### S^{k}

which are estimated to be effective as the set of constraints satisfied by an equality with the value z^{k} for the discrete variable at present and the constraints which are not satisfied. When optimization is carried out for the discrete variable, the value of a barrier function corresponding to the constraint is zero, where the following expression holds for

$$i ∈ S$$

$${\sum }_{j ∈ {K}^{i}} {β}_{ij} {z}_{j}^{k + 1} = {w}_{i} - 1.$$

Therefore, since the following expression holds in some cases, for

$${z}^{k + 1}$$

$${\sum }_{j ∈ {K}^{i}} {β}_{ij} {z}_{j}^{k + 1} \geq {w}_{i} - 1$$

an unnecessary constraint is removed from the constraint set estimated to be effective in the next iteration. Using the algorithm, a solution to the optimization problem (2), i.e., the optimization problem (1) can be obtained.

The specific algorithm may be as follows.

Math. 18
Algorithm 1 Minimization of (2)

```
Decide z^{b}, x^{b}, μ₁, μ₂, l, γ
η⁰ := 0, S⁰ = {i = 1, 2, . . . , mᵢ | Σ_{j∈K}, [symbol] xⱼ⁰ ≥ wᵢ}
for k = 0 to l − 1 do
  (Using Ising machine)
  z^{k+1} := arg min_{z} (z^{T}P, z + q₃^{T}z + η x^{iT}P, z + μ₁ Σᵢ₌₁^{m}^{₀}(Σ_{j∈} [symbol]  ,
    α [symbol]   − vᵢ)² + μ₂Σ [symbol]  (E_{j∈K}, [symbol] zⱼ − wᵢ + 0.5)²)
  (Using Classical computer)
  x^{k+1} := arg minₓ {x^{T}P, x + q₁^{T}x + η x^{T}P₃z^{k+1} | Ax = b, Cx ≤ d}
  γ^{k+1} := min{1, η^{k} + γ), S^{k+1} = {i = 1, 2, . . . , m₂ | Σ_{j∈K}, [symbol]   ≥ wᵢ}
end for [symbol]
:= xⁱ [symbol]
indicates data missing or illegible when filed
```

The discrete variable value storage unit 170 stores the following discrete variable calculated by the discrete variable optimizing unit 160 in each iteration.

[symbol]

^{k+1}

The continuous variable value storage unit 190 stores the following continuous variable calculated by the continuous variable optimizing unit 180 in each iteration.

x^{k+1}

The parameter storage unit 210 stores the parameter η^{k+1} calculated by the link changing unit 200 in each iteration and the following parameter calculated by the effective constraint estimating unit 220.

### S^{k+1}

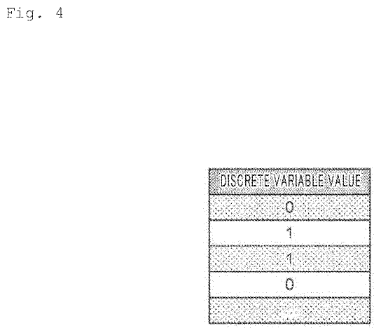

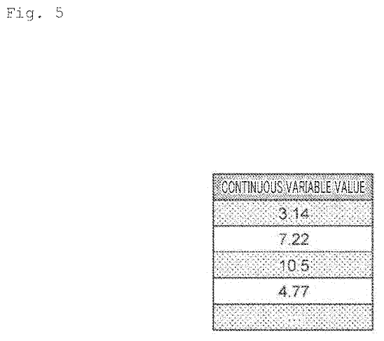

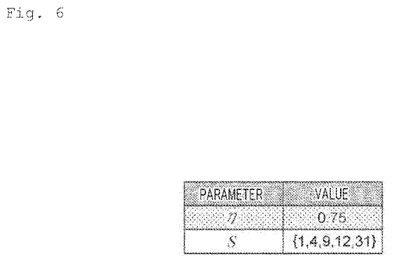

Examples of data stored in the discrete variable value storage unit 170 are shown in FIG. 4. Example of data stored in the continuous variable value storage unit 190 are shown in FIG. 5. Examples of data stored in the parameter storage unit 210 are shown in FIG. 6.

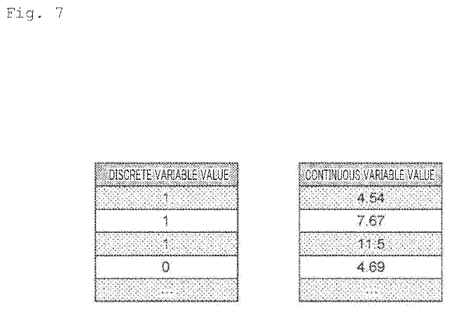

The output unit 250 reads a solution stored in the decision variable value storage unit 240 and outputs the solution. Examples of data stored in the decision variable value storage unit 240 are shown in FIG. 7.

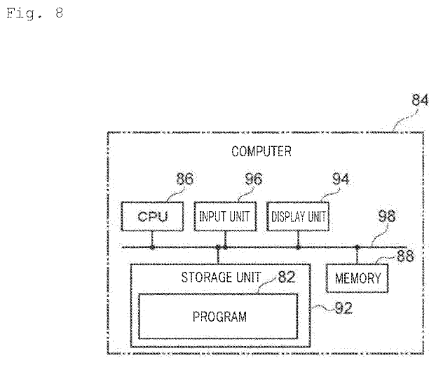

The problem solving device 10 is implemented for example by a computer 84 shown in FIG. 8. The computer 84 includes a CPU 86, a memory 88, a storage unit 92 which stores the program 82, a display unit 94 including a monitor, and an input unit 96 including a keyboard and a mouse. The CPU 86, the memory 88, the storage unit 92, the display unit 94, and the input unit 96 are connected to one another through a bus 98.

The storage unit 92 is implemented for example by an HDD, an SSD, or a flash memory. The program 82 for causing the computer 84 to function as the problem solving device 10 is stored in the storage unit 92. The CPU 86 reads out the program 82 from the storage unit 92 and expands the program 82 to the memory 88 to execute the program 82. The program 82 may be stored in a computer-readable medium and provided.

<Operations of the Problem Solving Device 10 According to the First Embodiment of the Present Invention>

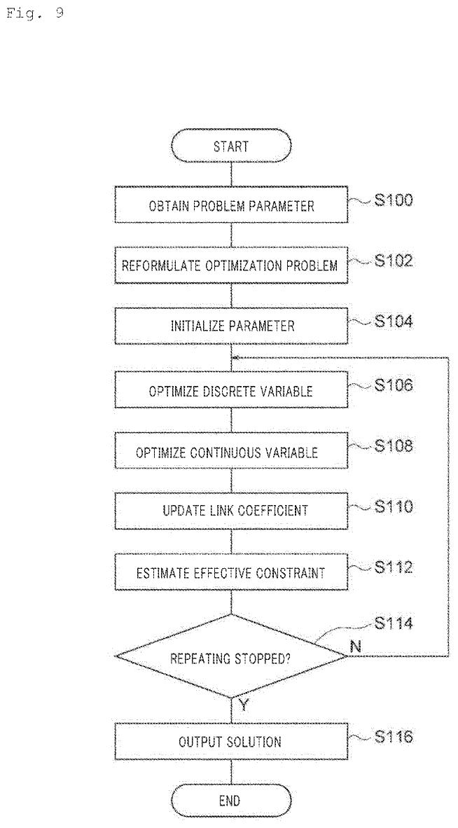

Next, the operation of the problem solving device 10 according to the embodiment of the present invention will be described. In the problem solving device 10, the operation unit 110 accepts, as a processing target, an optimization problem which can be formulated into a 0-1 mixed-integer quadratic programming problem in which constraints on discrete and continuous variables are separated and stores the constant parameter in the optimization problem to be processed in the problem parameter storage unit 120. The problem solving device 10 executes a problem solving processing routine illustrated in FIG. 9.

First, in step S100, the optimization problem reformulating unit 130 obtains the constant parameter in the optimization problem to be processed.

In step S102, the optimization problem reformulating unit 130 uses a problem parameter transmitted from the problem parameter storage unit 120 to formulate the problem into a 0-1 mixed-integer quadratic programming problem in which the constraints on discrete and continuous variables are separated.

In step S104, the management unit 150 initializes discrete and continuous variables, a link coefficient, and an effective constraint.

In step S106, the discrete variable optimizing unit 160 optimizes the discrete variable in the optimization problem formulated in step S102 when the continuous variable is fixed at a point on the basis of the discrete and continuous variables, link coefficient, and effective constraint.

In step S108, the continuous variable optimizing unit 180 optimizes the continuous variable in the optimization problem formulated in step S102 when the discrete variable is fixed on the basis of the discrete and continuous variables, link coefficient, and effective constraint.

In step S110, the link changing unit 200 updates the link coefficient η so that the influence of the term in which the discrete and continuous variables are multiplied by each other gradually increases.

In step S112, the effective constraint estimating unit 220 estimates, as an efficient constraint, a constraint not satisfied in the value of the discrete variable at present and satisfied by an equality among constraints on the discrete variable and including an inequality.

In step S114, the stop condition determining unit 230 determines whether the stop condition is satisfied. When the stop condition is satisfied, the management unit 150 proceeds to step S116, and when the stop condition is not satisfied, the management unit 150 repeats the processing from steps S106 to S114.

In step 3116, the output unit 250 reads and outputs the finally obtained continuous and discrete variables in steps S106 and S108 as a solution and ends the problem solving processing routines.

As in the foregoing, the problem solving device according to the first embodiment of the present invention reformulates an optimization problem to be processed into an optimization problem in which constraints on discrete and continuous variables are separated. The problem solving device repeats the following two steps. The first is to optimize the discrete variable in the reformulated optimization problem using an Ising machine while fixing the continuous variable at a point. The second is to optimize the continuous variable in the reformulated optimization problem using a classical computer while fixing the discrete variable at a point. This allows a solution to the optimization problem to be obtained while reducing the amount of computation.

In addition, the amount of computation can be reduced by using the Ising machine, and thus a solution can be obtained at high speed. In addition, taking advantage of the iteration solution approach, a barrier function can be introduced by estimating an effective constraint, so that a solution is allowed to satisfy the constraint.

In addition, the link coefficient representing the influence of the term in which the discrete variable and the continuous variable are multiplied by each other in the reformulated optimization problem can be changed by each iteration, the problem can be prevented from falling into a bad local solution, and the final objective function value can be a good value.

### Second Embodiment

According to a second embodiment of the invention, a vehicle power distribution scheduling problem having two power sources, an engine and electric power, will be considered. The optimization problem is the following optimization problem which has been formulated in the existing document (Reference 13).

$$\begin{matrix}[ Math . 9 ] & \\ min {η ( {E}_{T} - {E}^{m ax} )}^{2} + {\sum }_{t = 0}^{T - 1} \{ f ( {P}_{t}^{eng} , {z}_{t} ) + σ max \{ {z}_{t} - {z}_{t - 1} , 0 \} \} \\ s . t . {E}_{t + 1} = {E}_{t} - τ {P}_{t}^{batt} \\ {P}_{t}^{batt} + {P}_{t}^{eng} \geq {P}_{t}^{des} \\ {P}^{m ax} {z}_{t} \geq {P}_{t}^{eng} \geq 0 \\ {z}_{t} ∈ \{ 0 , 1 \} & ( 3 )\end{matrix}$$

Note however that the following holds.

$$f ( P , z ) = {α P}^{2} + β P + γ z$$

[Reference 13] Boyd, S., Vandenberghe, L. (2004). Convex optimization. Cambridge university press.

The decision variable for each t can be represented as follows:

$${E}_{t} , {P}_{t}^{eng} , {P}_{t}^{batt} , {z}_{t}$$

where these values are variables at time t which represent the remaining battery power, the amount of power from the engine, the amount of power from electricity, and the on-off of the power supply of the engine at time t. The constants are as follows:

$$η , {E}^{m ax} , T , σ , τ , {P}_{t}^{des} , {P}^{m ax} , α , β , γ$$

and these constants are a cost coefficient for the remaining power, the maximum amount of power held, the end time, a cost coefficient for starting the engine, the amount of power demand for each time, the maximum amount of power of the engine, a secondary coefficient in a cost function for the amount of power of the engine, a primary coefficient in the cost function for the amount of power of the engine, and the amount of a fixed cost during startup of the engine. As for an objective function, the following represents a cost function which increases as the remaining amount of power at the end time is smaller,

$${η ( {E}_{T} - {E}^{m ax} )}^{2}$$

the following is a cost function for the output by the engine,

$${\sum }_{t = 0}^{T - 1} f ( {P}_{t}^{eng} , {z}_{t} )$$

and the following is a cost function for starting by the engine.

$$σmax \{ {z}_{t} - {z}_{t - 1} , 0 \}$$

As for the constraints, the first is on the dynamic system for the remaining amount of power, the second is a constraint for the total power amount to exceed the power demand, and the third is a constraint on the power amount by the engine.

<Configuration of the Problem Solving Device According to the Second Embodiment of the Present Invention>

Next, the configuration of the problem solving device according to the second embodiment of the present invention will be described. Since the configuration of the problem solving device according to the second embodiment of the present invention is the same as that of the first embodiment, the components are designated by the same reference numerals and their detailed description will not be provided.

The problem parameter storage unit 120 stores constant parameters in an optimization problem, reads the constant parameters in response to a request from the problem solving device 10, and transmits the parameters to the optimization problem reformulating unit 130. Specifically, the parameters are the constant parameters in the optimization problem (3) and information about Pₜ^{des} at t=0, 1, . . . , T−1.

$$η , {E}^{m ax} , T , σ , τ , {P}^{m ax} , α , β , γ$$

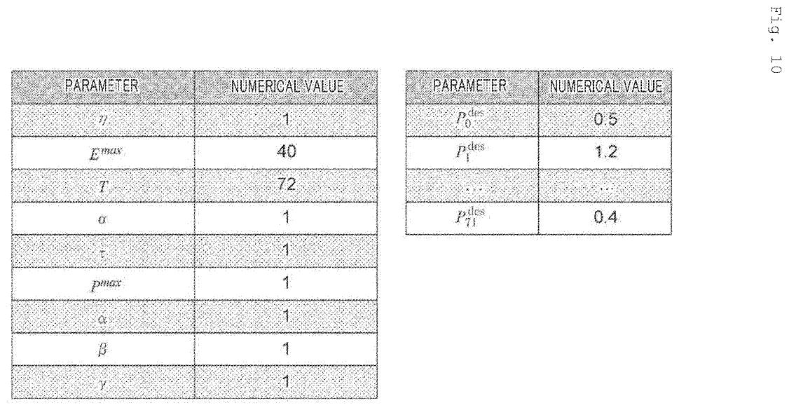

Examples of those stored in the problem parameter storage unit 120 are shown in FIG. 10.

The optimization problem reformulating unit 130 uses the problem parameters transmitted from the problem parameter storage unit 120 to formulate an optimization problem into a 0-1 mixed-integer quadratic programming problem in which the constraints on discrete and continuous variables are separated for the discrete variable and continuous variable. Hereinafter, an example of the formulation method will be described.

Introduction of a sufficiently large constant M allows the optimization problem (3) to be formulated as follows.

$$\begin{matrix}[ Math . 10 ] & \\ min {η ( {E}_{T} - {E}^{m ax} )}^{2} + {\sum }_{t = 0}^{T - 1} \{ f ( {P}_{t}^{eng} , {z}_{t} ) + σ {s}_{t} + M ( 1 - {z}_{t} ) {P}_{t}^{eng} \} \\ s . t . {E}_{t + 1} = {E}_{t - τ} {P}_{t}^{batt} \\ {P}_{t}^{batt} + {P}_{t}^{eng} \geq {P}_{t}^{des} \\ {P}^{m ax} \geq {P}_{t}^{eng} \geq 0 \\ {s}_{t} \geq {z}_{t} - {z}_{t\_ 1} \\ {z}_{t} ∈ \{ 0 , 1 \} , {s}_{t} ∈ \{ 0 , 1 \} & \end{matrix}$$

The problem is a 0-1 mixed-integer quadratic programming problem in which constraints on discrete and continuous variables are separated and can be changed into the following problem form by correct transformation.

$$\begin{matrix}[ Math . 11 ] & \\ min {x}^{⊤} {P}_{1} x + {q}_{1}^{⊤} x + {z}^{⊤} {P}_{2} z + {q}_{2}^{⊤} z + {x}^{⊤} {P}_{3} z + r \\ s . t . \\ {\sum }_{j ∈ {K}^{i}} {z}_{j} \leq {ω}_{i} , \\ i = 1 , 2 , … , {m}_{2} \\ Ax = b , \\ Cx \leq d \\ z ∈ {\{ 0 , 1 \}}^{{n}_{1}} , \\ x ∈ {ℝ}^{{n}_{2}} & ( 4 )\end{matrix}$$

Here, the decision variables are

x, [symbol]
and the constants are

$${P}_{1} , \\ {P}_{2} , \\ {P}_{3} , \\ {q}_{1} , \\ {q}_{2} , \\ r , \\ ω , \\ A , \\ b , \\ C , \\ d .$$

This is identical to the first embodiment described above, except that there is no equality term for the discrete variables and the optimization of the continuous variable part can be solved by an interior-point method.

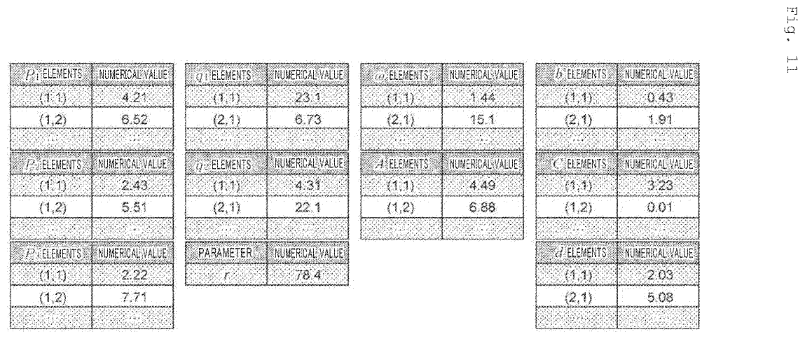

In this manner, the optimization problem (4) reformulated by the optimization problem reformulating unit 130 is stored in the optimization problem parameter storage unit 140. Examples of the stored parameters are shown in FIG. 11.

The optimization problem parameter storage unit 140 reads out an optimization problem parameter in response to a request from the problem solving device 10 and transmits the parameter to the management unit 150.

The management unit 150 calls the discrete variable optimizing unit 160, the continuous variable optimizing unit 180, the link changing unit 200, the effective constraint estimating unit 220, and the stop condition determining unit 230 according to the procedure of the algorithm which alternately optimizes the discrete and continuous variables which will be described. When it is determined that the number of iterations has reached a maximum number for iterations in the stop condition determining unit 230, the management unit 150 stores the solution obtained at the decision variable value storage unit 240. The following is a specific algorithm.

First, the discrete variable optimizing unit 160 optimizes the discrete variable in the optimization problem (4) when the continuous variable is fixed at a point. Specifically, the continuous variable in the optimization problem (4) is fixed as

x̅
then the constant term is removed, and a coefficient n is introduced to the following,

$${\overline{x}}^{⊤} {P}_{3} z ,$$

so that the optimization problem (4) as follows is obtained.

$$\begin{matrix}[ Math . 12 ] & \\ min {z}^{T} {P}_{2} z + {q}_{2}^{T} z + η {\overline{x}}^{T} {P}_{3} z \\ s . t . {\sum }_{j ∈ {K}^{i}} {z}_{j} \leq {w}_{i} , i = 1 , 2 , … , {m}_{2} \\ z ∈ {\{ 0 , 1 \}}^{{n}_{1}} & \end{matrix}$$

Here, η changes the degree of the influence of the term in which the continuous and discrete variables are multiplied by each other, and as n increases, the problem takes more into account the continuous variable:

x̅

The problem is changed as follows in order to solve the problem in each iteration using an Ising machine.

$$\begin{matrix}[ Math . 13 ] & \\ min {z}^{T} {P}_{2} z + {q}_{2}^{T} z + η {\overline{x}}^{T} {P}_{3} z + {μ}_{2} {\sum }_{i ∈ S} {( {\sum }_{j ∈ {K}^{i}} {z}_{j} - {w}_{i} + 0.5 )}^{2} & \end{matrix}$$

Here, the following term is a barrier function for the inequality constraint,

$${μ}_{2} {\sum }_{i ∈ S} {( {\sum }_{j ∈ {K}^{i}} {z}_{j} - {ω}_{i} + 0.5 )}^{2}$$

and when the penalty parameter μ₂ is sufficiently large, the solution is determined to satisfy the following expression as much as possible.

### For

$$i ∈ S$$

$${\sum }_{j ∈ {K}^{i}} {z}_{j} = {w}_{i} or {\sum }_{j ∈ {K}^{i}} {z}_{j} = {w}_{i} - 1$$

where

### S

represents an index set of constraints estimated to be effective among inequality constraints and is updated in each iteration in the algorithm.

Since the problem is an unconstrained quadratic programming problem with only 0-1 variables, it can be solved using each Ising machine.

As for inequality constraints in discrete variables, there has been a new proposed approach for changing them into equality constraints by introducing a new variable (Reference 12), but the above approach for estimating the effective constraint does not require introduction of new variables, which enables easy implementation on an Ising machine which is limited in the number of variables.

Next, the continuous variable optimizing unit 180 optimizes the continuous variable in the optimization problem (4) when the discrete variable is fixed. The discrete variable in the original problem (4) is fixed as

[symbol]

the constant term is removed, and when a coefficient η is introduced to the following

$${x}^{⊤} {P}_{3} \overline{z}$$

the following optimization problem is obtained.

$$min {x}^{⊤} {P}_{1} x + {q}_{1}^{⊤} x + {η x}^{⊤} {P}_{3} \overline{z} \\ s . t . \\ Ax = b , \\ Cx \leq d \\ x \leq {ℝ}^{{n}_{2}} \qquad [ Math . 14 ]$$

Here, as η increases, the resulting problem takes the discrete variable z more into account.

The above optimization problem is a convex quadratic programming problem since P₁ is a positive semidefinite symmetric matrix due to the characteristics of problem (3). Therefore, the above optimization problem can be solved using various interior-point methods such as a primal-dual interior point method.

In addition to the optimization of the discrete variable part and the optimization of the continuous variable part, the specific algorithm for updating each parameter is as follows.

Math. 15
Algorithm 2 Minimization of (4)

```
Decide z⁰, x⁰, μ₂, I
η⁰ := 0, S⁰ = [i = 1, 2, . . . m [symbol]   | Σ_{i∈k}, [symbol]  ≥ wᵢ]
for k = 0 to i − 1 do
  (Using Ising machine)
  z^{k+1} := arg min [symbol]   (z^{T}P, z + q₃^{T}z + ηx^{iT}P, z + μ₃Σ [symbol]
  (Σ_{j∈K}, zⱼ − wᵢ + 0.5)²)
  (Using Classical computer)
  x^{k+i} = arg minₓ {x^{T}P, x + q₁^{γ}x + η x^{T} P, z^{k+1} | Ax = b, Cx ≤ d}
  η = η + [symbol] , S^{k+1} = {i = 1, 2, . . . , m₃ | Σ_{j∈k}, z [symbol]  ^{b+1} ≥ wᵢ}
end for [symbol]
= xⁱ [symbol]
indicates data missing or illegible when filed
```

In the above algorithm, the set of constraints estimated to be effective as follows includes constraints effective with the value z^{k} for the discrete variable at present and constraints which is not satisfied.

When optimization is carried out to the discrete variable, the value of the barrier function corresponding to the constraint is zero when the following holds.

$$i ∈ {S}^{k}$$

$${\sum }_{j ∈ {K}^{i}} {z}_{j}^{k + 1} = {w}_{i} - 1$$

Therefore, the following inequality holds in some cases.

### For

$${z}^{k + 1}$$

$${\sum }_{j ∈ {K}^{i}} {z}_{j}^{k + 1} \geq {ω}_{i} - 1$$

Therefore, unnecessary constraints are removed from the set of constraints estimated to be effective in the next iteration. Using the algorithm, the solution to the optimization problem (4) or the optimization problem (3) can be obtained.

The discrete variable value storage unit 170 stores the following discrete variable calculated by the discrete variable optimizing unit 160 in each iteration.

$${z}^{k + 1}$$

The continuous variable value storage unit 190 stores the following continuous variable calculated by the continuous variable optimizing unit 180 in each iteration.

$${x}^{k + 1}$$

The problem parameter storage unit 120 stores the parameter η^{k+1} calculated by the link changing unit 200 and the following parameter calculated by the effective constraint estimating unit 220 in each iteration.

$${S}^{k + 1}$$

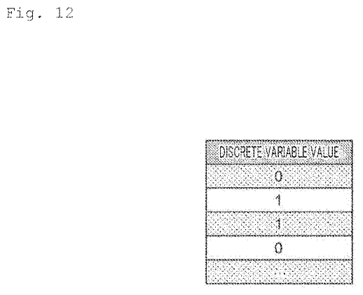

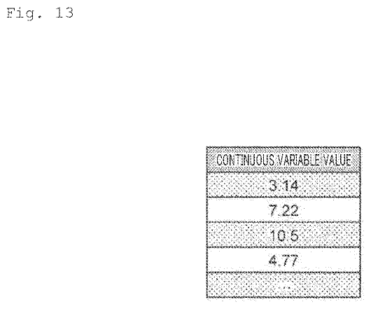

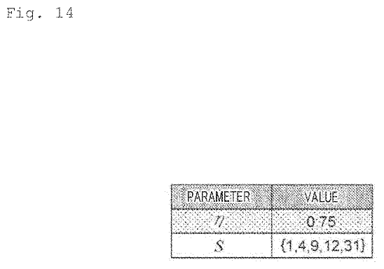

Examples of data stored in the optimization problem parameter storage unit 140 are shown in FIG. 11. Examples of data stored in the discrete variable value storage unit 170 are shown in FIG. 12. Examples of data stored in the continuous variable value storage unit 190 are shown in FIG. 13. Examples of data stored in the parameter storage unit 210 are shown in FIG. 14.

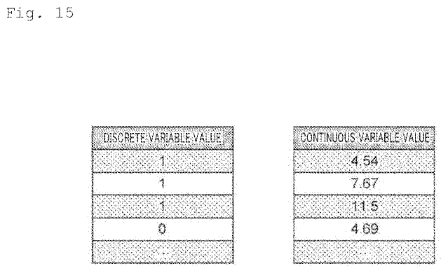

The output unit 250 reads the solution stored in the decision variable value storage unit 240 and outputs the solution. Examples of data stored in the decision variable value storage unit 240 are shown in FIG. 15.

Note that the other configuration and operation of the problem solving device 10 according to the second embodiment are the same as those of the first embodiment and therefore will not be described.

As in the foregoing, the problem solving device according to the second embodiment of the present invention reformulates an optimization problem as a processing target into an optimization problem in which constraints on discrete and continuous variables are separated. The problem solving device repeats the following two steps. The first is to optimize the discrete variable in the reformulated optimization problem while fixing the continuous variable at a point using an Ising machine. The second is to optimize the continuous variable in the reformulated optimization problem using a classical computer while fixing the discrete variable at a point. This allows a solution to the optimization problem to be obtained while reducing the amount of computation.

Note that the present invention is not limited by the above-described embodiments, and various modifications and applications can be made without departing from the gist of the present invention.

### REFERENCE SIGNS LIST

10 Problem solving device
20 Arithmetic unit
82 Program
84 Computer
100 Optimizing unit
110 Operation unit
120 Problem parameter storage unit
130 Optimization problem reformulating unit
140 Optimization problem parameter storage unit
150 Management unit
160 Discrete variable optimizing unit
170 Discrete variable value storage unit
180 Continuous variable optimizing unit
190 Continuous variable value storage unit
200 Link changing unit
210 Parameter storage unit
220 Effective constraint estimating unit
230 Stop condition determining unit
240 Decision variable value storage unit
250 Output unit

1. A problem solving device for outputting a solution to an optimization problem which is a quadratic programming problem including a discrete variable and a continuous variable and which can be formulated into a quadratic programming problem having a constraint on the discrete variable and a constraint on the continuous variable in a separated state, the device comprising:
an optimization problem reformulator configured to reformulate an optimization problem as a processing target into an optimization problem in which the constraint on the discrete variable and the constraint on the continuous variable are separated;
a discrete variable optimizer configured to optimize the discrete variable in the reformulated optimization problem while fixing the continuous variable at a first point;
a continuous variable optimizer configured to optimize the continuous variable in the reformulated optimization problem while fixing the discrete variable at a second point;
a link changer configured to change a link coefficient representing the influence of a term in which the discrete variable and the continuous variable are multiplied by each other in the reformulated optimization problem; and
a controller configured to cause the optimization by the discrete variable optimizer, the optimization by the continuous variable optimizer, and the changing by the link changer to be repeated until a predetermined stop condition is satisfied.

2. The problem solving device according to claim 1, further comprising:
an effective constraint estimator configured to estimate, as an effective constraint, a constraint not satisfied in a solution at present and a constraint satisfied by an equality among constraints on the discrete variable including an inequality, wherein the manager causes the optimization by the discrete variable optimizer, the optimization by the continuous variable optimizer, the changing by the link changer, and the estimation by the effective constraint estimator to be repeated until a predetermined stop condition is satisfied.

3. The problem solving device according to claim 1, wherein the discrete variable optimizer optimizes the discrete variable in the reformulated optimization problem using an Ising machine.

4. A problem solving method in a problem solving device for outputting a solution to an optimization problem which is a quadratic programming problem including a discrete variable and a continuous variable and which can be formulated into a quadratic programming problem having a constraint on the discrete variable and a constraint on the continuous variable in a separated state, the method comprising:
reformulating, by an optimization problem reformulator, an optimization problem as a processing target into an optimization problem in which the constraint on the discrete variable and the constraint on the continuous variable are separated using the optimization problem reformulator;
optimizing, by a discrete variable optimizer, the discrete variable in the reformulated optimization problem while fixing the continuous variable at a first point using the discrete variable optimizer;
optimizing, by a continuous variable optimizer, the continuous variable in the reformulated optimization problem while fixing the discrete variable at a second point using the continuous variable optimizer;
changing, by a link changer, a link coefficient representing the influence of a term in which the discrete variable and the continuous variable are multiplied by each other in the reformulated optimization problem using the link changer; and
repeating, by a controller, the optimization by the discrete variable optimizer, the optimization by the continuous variable optimizer, and the changing by the link changer until a predetermined stop condition is satisfied using the controller.

5. The problem solving method according to claim 4, further comprising:
estimating, by an effective constraint estimator as an effective constraint, a constraint which satisfies an equality in a solution among constraints on the discrete variable including an inequality using the effective constraint estimator, wherein in the repeating step using the controller, the optimization by the discrete variable optimizer, the optimization by the continuous variable optimizer, the changing by the link changer, and the estimation by the effective constraint estimating unit are repeated until a predetermined stop condition is satisfied.

6. The problem solving method according to claim 4, wherein in the optimization using the discrete variable optimizer, the discrete variable in the reformulated optimization problem is optimized using an Ising machine.

7. A computer-readable non-transitory recording medium storing a computer-executable program instructions for performing problem solving processing for outputting a solution to an optimization problem which is a quadratic programming problem including a discrete variable and a continuous variable and which can be formulated into a quadratic programming problem having a constraint on the discrete variable and a constraint on the continuous variable in a separated state, that when executed by a processor cause a computer to process:
reformulating, by an optimization problem reformulator, an optimization problem as a processing target into an optimization problem in which the constraint on the discrete variable and the constraint on the continuous variable are separated;
optimizing, by a discrete variable optimizer, the discrete variable in the reformulated optimization problem while fixing the continuous variable at a first point;
optimizing, by a continuous variable optimizer, the continuous variable in the reformulated optimization problem while fixing the discrete variable at a second point;
changing, by a link changer, a link coefficient representing the influence of a term in which the discrete variable and the continuous variable are multiplied by each other in the reformulated optimization problem; and
repeating, by a controller, the optimization for the discrete variable by the discrete variable optimizer, the optimization for the continuous variable by the continuous variable optimizer, and the changing for the link coefficient by the link changer until a predetermined stop condition is satisfied.

8. The problem solving device according to claim 2, wherein the discrete variable optimizer optimizes the discrete variable in the reformulated optimization problem using an Ising machine.

9. The problem solving method according to claim 4, wherein in the optimization using the discrete variable optimizer, the discrete variable in the reformulated optimization problem is optimized using an Ising machine.

10. The computer-readable non-transitory recording medium of claim 7, the computer-executable program instructions when executed further causing the computer to process:
estimating, by an effective constraint estimator as an effective constraint, a constraint which satisfies an equality in a solution among constraints on the discrete variable including an inequality using the effective constraint estimator, wherein in the repeating step using the controller, the optimization by the discrete variable optimizer, the optimization by the continuous variable optimize, the changing by the link changer, and the estimation by the effective constraint estimating unit are repeated until a predetermined stop condition is satisfied.

11. The computer-readable non-transitory recording medium of claim 7, wherein the discrete variable optimizer optimizes the discrete variable in the reformulated optimization problem using an Ising machine.

12. The computer-readable non-transitory recording medium of claim 10, wherein the discrete variable optimizer optimizes the discrete variable in the reformulated optimization problem using an Ising machine.
